(19) United States
(12) Patent Application Publication
(10) Pub. No.: US 2012/0194556 A1
(43) Pub. Date: Aug. 2, 2012

(54) 3D AVIONICS VIEWPOINT CONTROL SYSTEM

(75) Inventors: John M. Schmitt, Phoenix, AZ (US); Jonathan A. Price, Phoenix, AZ (US)

(73) Assignee: L3 Communications Avionics Systems, Inc., Grand Rapids, MI (US)

(21) Appl. No.: 13/357,312

(22) Filed: Jan. 24, 2012

Related U.S. Application Data
(60) Provisional application No. 61/437,031, filed on Jan. 28, 2011.

(51) Int. Cl. G09G 5/00

(52) U.S. Cl. 345/641; 345/650

(57) ABSTRACT

The present invention provides a system and method for displaying exocentric views of an aircraft in a three-dimensional manner, wherein a pilot, or other user, can select from a plurality of different exocentric viewpoints. The user can thus see a three-dimensional rendering of the terrain, obstacles, and/or other images around the aircraft from vantage points other than the egocentric vantage point of most aircraft display systems. This enables the pilot to easily increase his or her situational awareness.

### CROSS-REFERENCE TO RELATED APPLICATION

This application claims priority from U.S. provisional patent application Ser. No. 61/437,031, filed on Jan. 28, 2011, the disclosure of which is hereby incorporated herein by reference in its entirety.

### BACKGROUND OF THE INVENTION

The present invention relates to avionics displays, and more particularly to a system for displaying exocentric views of an aircraft in which the display is positioned.

### SUMMARY OF THE INVENTION

The present invention provides a system and method for displaying exocentric views of an aircraft in a three-dimensional manner wherein a pilot, or other user, can select from a plurality of different exocentric viewpoints. The user can thus see a three dimensional rendering of the terrain, obstacles, and/or other images around the aircraft from vantage points other than the egocentric vantage point of most aircraft display systems. This enables the pilot to easily increase his or her situational awareness.

An avionics display system, according to an aspect of the invention, is provided that includes a controller, a database, a display, and a user interface. The controller communicates with a navigation system of an aircraft that determines a location and heading of the aircraft. The database contains terrain data for a defined geographical area of Earth. The display communicates with the controller and depicts a three dimensional image of terrain that is based upon the terrain data contained within the database. The controller is adapted to display an aircraft image depicted from a particular viewpoint wherein the aircraft image is displayed at a location relative to the terrain image corresponding to the aircraft's actual location. The user interface allows a user to change the particular viewpoint whereby the aircraft image and the terrain image are changed in a manner corresponding to the changed viewpoint.

An avionics display system, according to an aspect of the invention, includes a display, a controller, and a user interface. The controller causes the display to display a synthetic vision rendering of terrain over which an aircraft is currently positioned. The controller further causes the display to display an exocentric aircraft image at a location representative of the aircraft's current location relative to the rendered terrain. The user interface allows a user to change a viewpoint upon which the exocentric aircraft image and rendered terrain are based. The user interface may include a graphic image positioned on a touch screen. The graphic image, whether positioned on a touch screen or other type of screen, may include a circle positioned around an aircraft icon whereby selecting a portion of the circle changes the viewpoint. The selection of the portion of the circle may be carried out by pushing on a touch screen or by manipulating a computer mouse, or by other means. The system may be configured such that the viewpoint can be changed both horizontally and vertically by the user. In some embodiments, the viewpoint may be changed only in pre-selected angular increments greater than at least one degree. Alternatively, the viewpoint may be changed in increments that are adjustable by a user.

The display may be part of an electronic flight bag, a multi-function display, a primary flight display, or any other type of avionics display that might be used in a cockpit. Still further, the user interface may include a graphic image having a circle positioned around an aircraft icon pointing in a particular direction, whereby selecting a portion of the circle changes the viewpoint of the aircraft image displayed to the user to have an angular relationship that matches the portion of the circle relative to the aircraft icon.

These and other objects, advantages and features of this invention will become apparent upon review of the following specification in conjunction with the drawings.

### BRIEF DESCRIPTION OF THE DRAWINGS

FIG. 1 is a schematic diagram of an avionics display system according one embodiment;

FIG. 2 is an illustrative screen shot that may be displayed on the avionics display system showing an exocentric view from a first perspective;

FIG. 3 is an illustrative screen shot that may be displayed on the avionics display system showing an exocentric view from a second perspective;

FIG. 4 is an illustrative screen shot that may be displayed on the avionics display system showing an exocentric view from a third perspective; and

FIG. 5 is an illustrative screen shot that may be displayed on the avionics display system showing an exocentric view from a fourth perspective.

### DETAILED DESCRIPTION OF THE EMBODIMENTS

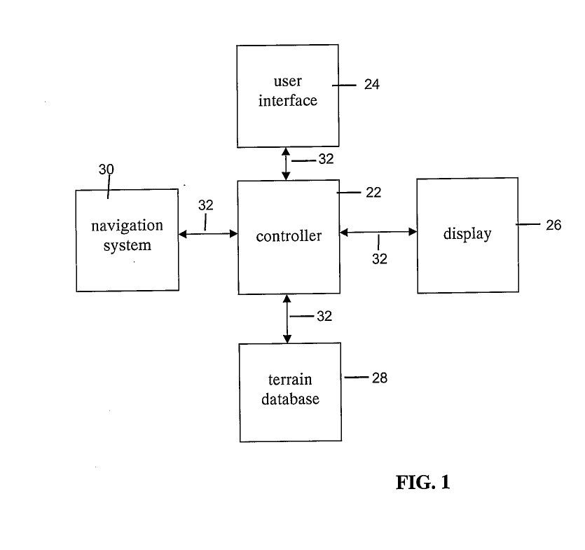

An avionics display system 20 according to one embodiment is depicted in block diagram form in FIG. 1. Avionics display system 20 is a system that may be installed within the cockpit of an aircraft in order to provide information about the locations of other aircraft. Such information provides the pilot with greater situational awareness and may aid the pilot in avoiding conflicts with the other air traffic. Alternatively, display system 20 may be a portable system that can be carried out of an airplane while not in use, and connected to the navigation system of an aircraft when in use.

In the embodiment depicted in FIG. 1, display system 20 includes a controller 22, a user interface 24, a display 26, and a terrain database 28. Display system 20 is constructed to interface with an aircraft's navigation system 30. As will be discussed more below, navigation system 30 provides display system 20 with the current location of the aircraft, including its current heading and altitude. Navigation system 30 may be any type of conventional navigation system that is used aboard aircraft, and may include such components as GPS receivers, gyroscopes, accelerometers, transponders, air data sensors and processors, and/or air data and attitude heading reference systems (ADAHRS), or still other components. The particular arrangement of components of navigation system 30 may vary from craft to craft.

Controller 22 may comprise one or more microprocessors, systems-on-a-chip (SoC), field-programmable gate array, discrete logic circuits, or any other electronic structure or combinations of electronic structures capable of carrying out the algorithms discussed herein, as would be known to one of ordinary skill in the art. Such algorithms may be carried out in software, firmware, or dedicated hardware, or any combination of these. Controller 22 may include multiple components that are located at different physical locations within the cockpit, including one or more components positioned physically inside a first device, one or more additional components positioned inside a second device, and possibly additional components positioned inside other devices.

Controller 22 communicates with the other components shown in FIG. 1 over one or more communication links 32. Communication links 32 may take on a variety of different forms, depending upon the location and construction of controller 22 and the particular configuration of system 20. In one embodiment, one or more of communication links 32 may be standard electrical busses, such as an Aeronautical Radio, Incorporated (ARINC) 429 bus, or any other type of bus suitable for use in an aircraft. In still other embodiments, one or more communications links 32 may be a purely internal communications link in which information is shared within a common physical unit, For example, in some embodiments, controller 22, display 26, user interface 24, and terrain database 28 may all be included within one common physical unit. Other variations are also possible.

Display 26 is adapted to display images to a pilot or other crew member. The physical construction of display 26 may vary, but in one embodiment it includes a Liquid Crystal Display (LCD). In other embodiments, display 26 may include a cathode ray tube (CRT) or a plasma screen display, or any other type of display capable of displaying graphic images to a pilot. The images displayed by display 26 are based upon information generated from controller 22. Such information may be transmitted from controller 22 to display 26 over a link 32 that, as noted, may be an internal or external electrical bus, or any other electrical component that enables controller 22 to communicate information to display 26 for display thereon. In some embodiments, display 26 may be associated with one or more graphics processors that control the images displayed on display 26. Such a graphic processor, if present, may be considered part of controller 22, or it may be considered separate from controller 22.

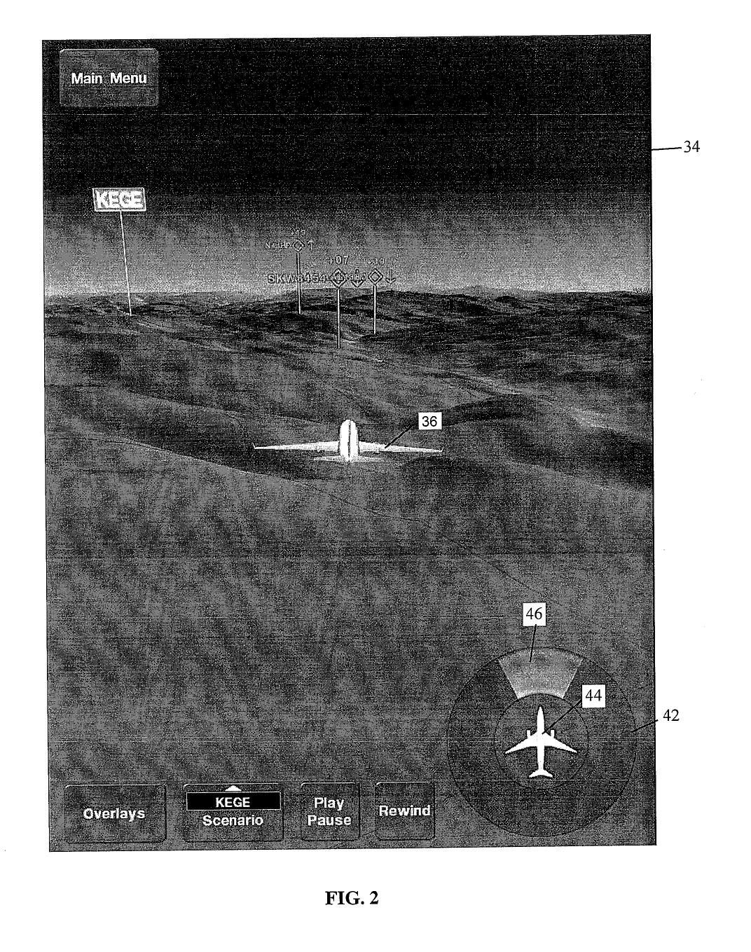

System 20 is adapted to display three dimensional exocentric images that indicate the aircraft's current location and heading. An exocentric image is an image illustrating a view or scene taken from a vantage point other than the pilot's viewpoint or the cockpit's viewpoint. In some instances, an exocentric view corresponds to an image rendered from the perspective or vantage point of an imaginary viewer positioned outside of the aircraft and looking at the aircraft. FIGS. 2-5 all illustrate exocentric views.

Turning to FIG. 2, a screen shot 34 shows an exocentric view of an aircraft image 36 and a terrain image 38. The exocentric view of FIG. 2 is taken from the vantage point of a person positioned behind and slightly above the aircraft image 36. Aircraft image 36 represents the actual aircraft in which system 20 is positioned, and the terrain image 38 represents the actual terrain over which the aircraft if currently flying. Controller 22 renders the overall images of screen shot 34 by using the location, heading, and altitude information provided by navigation system 30, as well as the terrain data supplied from terrain database 28. The rendering of the three dimensional images shown in FIG. 2 may be carried out using known algorithms for creating synthetic vision displays in aircraft cockpits. Generally speaking, controller 22 receives the aircraft's current location, heading, and altitude and uses this data to retrieve terrain data from terrain database 28 that corresponds to the aircraft's current position. The specific terrain data retrieved may also be dependent upon the aircraft's current heading and altitude. From the retrieved terrain data, controller 22 renders a terrain image 38 that approximates the actual terrain over which the aircraft is currently flying.

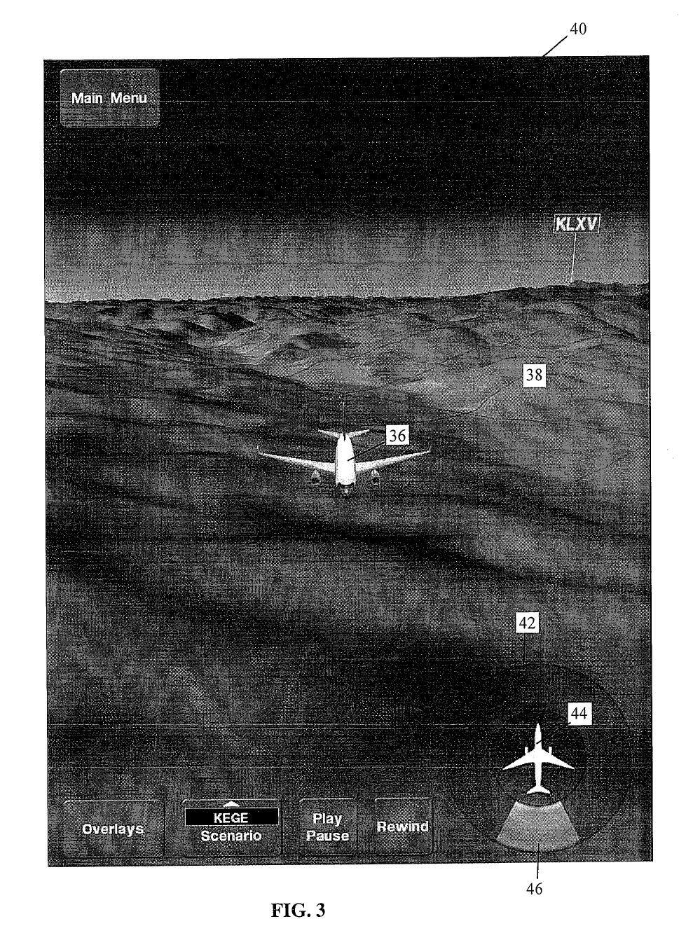

Avionics system 20 enables the pilot, or other user, to select the particular exocentric view that he or she wishes to have displayed on display 26. As noted, the screen shot 34 of FIG. 2 shows the aircraft and terrain from the perspective of an imaginary person positioned behind and above the aircraft—essentially a rear exocentric view. System 20 enables the pilot to change this viewpoint or perspective. By appropriately manipulating user interface 24, the pilot may change the perspective to a front exocentric view, such as that shown in FIG. 3, or to another perspective. Screen shot 40 of FIG. 3 includes a terrain image 38 that matches the current terrain over which the aircraft is flying. Further, unlike the terrain image 38 of FIG. 2, which includes terrain depicted far in front of the aircraft, FIG. 3 includes terrain depicted far behind the aircraft.

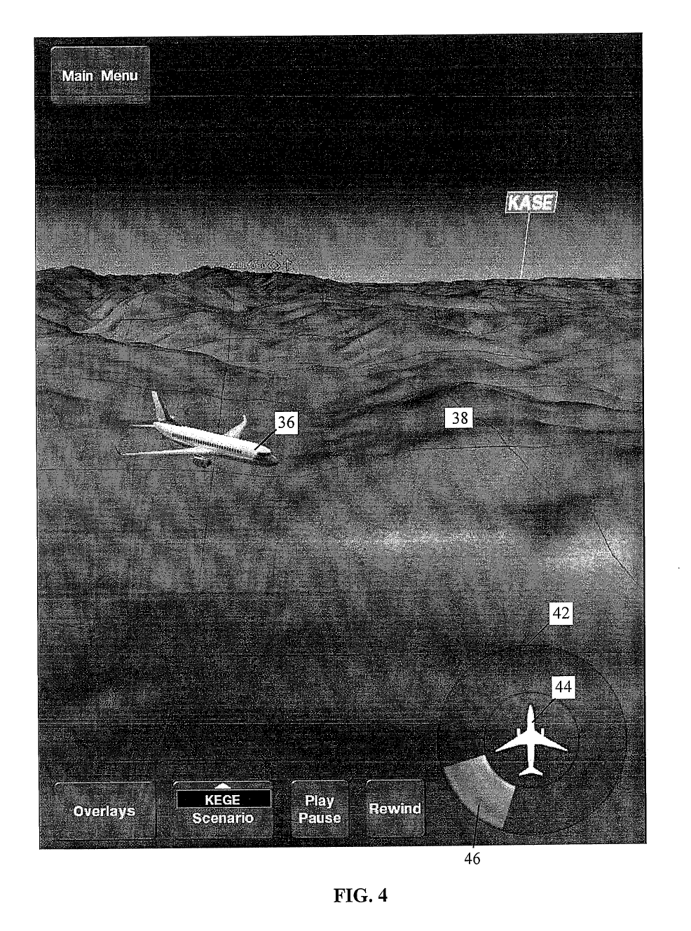

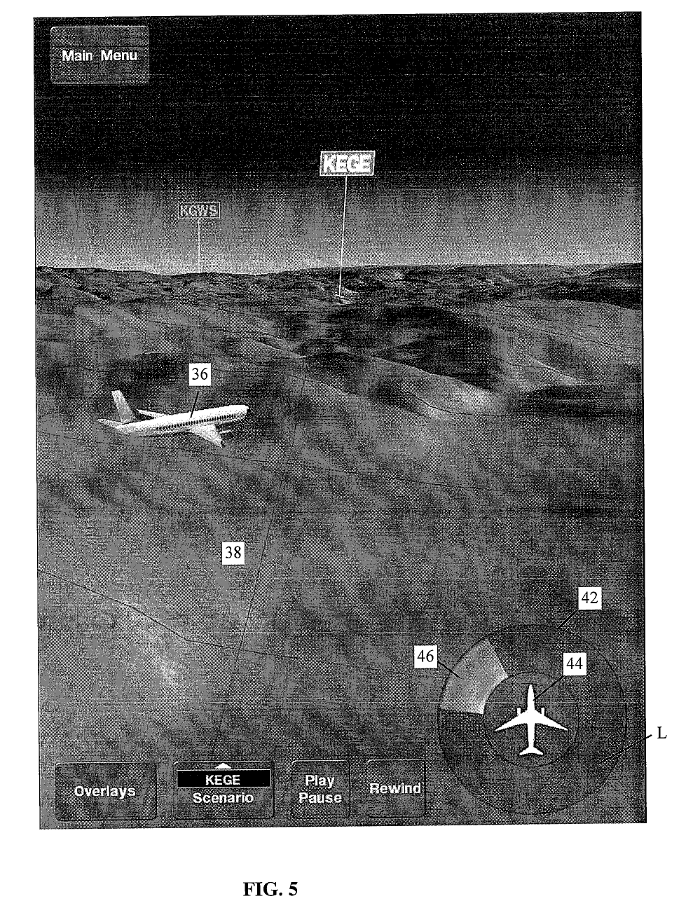

FIGS. 4 and 5 illustrate other exocentric views that may be selected by the pilot. Specifically, FIG. 4 shows an exocentric viewpoint from the perspective of a viewer positioned slightly in front of, and above, the right side of the aircraft. FIG. 5 shows an exocentric viewpoint from the perspective of a viewer positioned slightly behind, and above, the right side of the aircraft. In all of the images of FIGS. 2-5, the aircraft image 36 is adjusted along with the terrain image 38 to match the chosen viewpoint.

It will be understood by those skilled in the art that the images shown in FIGS. 2-5 are but images shown at one brief moment in time to the pilot. System 20 is configured to update and change the images shown on display 26 in substantially real time, such as multiple times a second. Thus, the images shown on display 26 are more akin to a synthetic vision movie—rather than isolated still images—depicting the aircraft and terrain as it moves. Further, as can be seen in FIGS. 2-5, other information may be displayed on the screen besides the terrain and aircraft images. Such information may include waypoints, navigation aids, obstacles, other traffic, weather, or any other information that is usefully displayed to the pilot.

As shown in FIGS. 2-5, a graphical symbol 42 is depicted in the lower right corner of the screen that encircles an aircraft icon 44. Graphical symbol 42 is a circle in the embodiment depicted, but could be any other symbol. User interface 24 may be a touch screen, a computer mouse, a directional controller such as a joystick or directional pad, a cursor control device, a motion capture device, or any other suitable user interface device.

In the illustrated embodiments, the pilot may use user interface 24 to select the desired exocentric view by either touching with his or her finger the desired location on graphical symbol 42, or by dragging and clicking a computer mouse on the desired location on graphical symbol 42. Such action will cause controller 22 to automatically change the images displayed on display 26 to match the chosen exocentric viewpoint and current terrain.

The graphical symbol 42 may include a color changing or highlighting feature that helps to identify which perspective a person has chosen. For example, in all of FIGS. 2-5, symbol 42 includes a highlighted portion 46 that illustrates which direction a person is looking toward relative to the aircraft. Thus, for example, in FIG. 5, the exocentric view displayed on display 26 corresponds to the viewpoint of a person positioned behind and to the side of the aircraft, such as at location L, and looking toward the aircraft in the direction of highlighted portion 46.

The particular aircraft image 36 displayed on display 26 may be an image that corresponds to the actual aircraft in which system 20 is positioned, or it may correspond to the general type of aircraft in which system 20 is positioned, or it may be a generic aircraft symbol. For example, if system 20 is installed in a Cessna 182, system 20 may be configured such that aircraft image 36 will be of a Cessna 182. Alternatively, aircraft image 36 might be of a generic single engine, fixed wing aircraft that only changes if system 20 is installed in a different type of aircraft, such as a twin engine plane, or something else. Or, as yet another alternative, aircraft image 36 may be the same regardless of what type of aircraft system 20 is installed in.

In the various embodiments disclosed herein, the selection of a particular exocentric viewpoint may be configured to allow a pilot to select any angular perspective. For example, if the pilot wants to view the plane from an angle of 93 degrees, system 20 would allow this. Further, in some embodiments, the particular angle of the viewpoint could be further refined down to increments that are even less than one degree, such as infinitesimal amounts (e.g. amounts as low as 100^{th} of a degree or lower). Indeed, in some embodiments, the angular increments could be as low as the sensitivity of the user input device.

In other embodiments, the different viewpoints that may be selected by the pilot could be limited to a smaller number with fixed angular relationships. For example, in one embodiment, system 20 might allow the pilot to choose only eight different perspective viewpoints: front, rear, left side, right side, right side forward, right side rearward, left side forward, and left side rearward. In such a system, the angular increments would be divided into increments of roughly forty-five degrees (360 degrees divided by eight). In other embodiments, different numbers of fixed increments could be implemented. In still other embodiments, system 20 could allow the pilot to choose what types of increments were available.

If system 20 is configured to display only exocentric views taken from perspectives of pre-defined angular increments, then user interface 24 could be configured such that, when a pilot pushes on or mouse clicks on, any segment of graphical circle symbol 42, the increment closest to the precise location on symbol 42 that the pilot selected would be displayed. In other words, if the pilot mouse clicked at a location of, say, 54 degrees on circle 42, and system 20 was configured to display only 45 degree increments, then system 20 would display an exocentric view from a forty-five degree angle relative to the aircraft. Alternatively, if system 20 is configured to allow any angular viewpoint to be chosen, then clicking on the 54 degree portion of circle 42 would result in an exocentric viewpoint being displayed on display 26 from an angle of 54 degrees.

The graphical symbol 42 in FIGS. 2-5 illustrates different horizontal viewpoints that may be selected and changed by a pilot. In other embodiments, system 20 could be configured to allow a pilot to change vertical viewpoints as well. Such a system may include another graphical symbol 42 that encircles an aircraft icon 44 that depicts the aircraft in profile view, rather than plan view. In such a system, selecting the symbol 42 would change the vertical component of the selected viewing angle. Such a system would allow the pilot to see images from viewpoints that showed the bottom of the aircraft, or the top of the aircraft, as well as the terrain directly underneath the aircraft, or any weather, traffic, or other things that may be directly above the aircraft. Thus, system 20 can be configured to allow viewpoint selections that change both horizontally and/or vertically.

In other embodiments, one or more of the components identified in FIG. 1 may be eliminated from display system 20. For example, in some embodiments, it is not necessary for display system 20 to be in communication with a navigation system 30. In such a system, a user can select any arbitrary location at which he or she wishes to see terrain and/or other information. Once the location is selected by the user, controller 22 causes display 26 to display the terrain and/or other information that corresponds to that location. Further, once that location has been selected, the pilot can then manipulate user interface 24 in the appropriate manner to select the specific viewpoint or vantage point from which he or she wants to view the selected location. Thus, for example, a pilot could use system 20 to look ahead to a specific location along his or her flight path, say a waypoint, and see the terrain, obstacles, traffic, and/or other information in a three dimensional manner at that selected location. Further, the pilot would be able to select the desired viewpoint for the selected location. The viewpoint selection could be changed either horizontally, vertically, or both. Still further, the selected location could be any arbitrary location, regardless of whether it was on a flight plan or not.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. An avionics display system comprising:
a controller in communication with a navigation system of an aircraft, said navigation system adapted to determine a location and heading of the aircraft;
a database containing terrain data for a defined geographical area of Earth;
a display in communication with said controller, said controller adapted to depict a three dimensional image of terrain on said display, said terrain image based upon said terrain data contained within said database, said controller further adapted to display an aircraft image depicted from a particular viewpoint wherein said aircraft image is displayed at a location relative to said terrain image corresponding to the aircraft's actual location; and
a user interface adapted to allow a user to change said particular viewpoint wherein the aircraft image and the terrain image are changed in a manner corresponding to the changed particular viewpoint.

2. The system of claim 1 wherein said user interface includes a graphic image positioned on a touch screen.

3. The system of claim 2 wherein said user interface includes a graphic image having a circle positioned around an aircraft icon wherein selecting a portion of the circle changes the particular viewpoint.

4. The system of claim 3 wherein the selecting a portion of the circle is carried out by pushing on a touch screen.

5. The system of claim 3 wherein selecting a portion of the circle is carried out by at least one of the following: a computer mouse, a directional controller, a cursor control device, or a motion capture device.

6. The system of claim 1 wherein said particular viewpoint can be changed both horizontally and vertically.

7. The system of claim 1 wherein said particular viewpoint can be changed only in pre-selected angular increments greater than at least one degree.

8. The system of claim 1 wherein said particular viewpoint can be changed in increments that are adjustable by a user.

9. The system of claim 1 wherein said particular viewpoint can be changed in infinitesimal amounts.

10. The system of claim 1 wherein said display is part of an electronic flight bag.

11. The system of claim 1 wherein said user interface includes a graphic image having a circle positioned around an aircraft icon pointing in a particular direction, and wherein selecting a portion of the circle changes the particular viewpoint of the aircraft image displayed to the user to have an angular relationship that matches the portion of the circle relative to the aircraft icon.

12. An avionics display system for an aircraft, comprising:
a display;
a controller adapted to display on said display a synthetic vision rendering of terrain at a location selected by a pilot;
said controller adapted to display on said display an exocentric aircraft image at a location representative of the aircraft's current location relative to the rendered terrain; and
a user interface adapted to allow a user to change a viewpoint from which the aircraft image and the terrain at said location are displayed.

13. The system of claim 12 wherein said user interface includes a graphic image positioned on a touch screen.

14. The system of claim 13 wherein said user interface includes a graphic image having a circle positioned around an aircraft icon wherein selecting a portion of the circle changes the viewpoint.

15. The system of claim 14 wherein the selecting a portion of the circle is carried out by pushing on a touch screen.

16. The system of claim 14 wherein selecting a portion of the circle is carried out by a computer mouse.

17. The system of claim 12 wherein said viewpoint can be changed both horizontally and vertically.

18. The system of claim 12 wherein said viewpoint can be changed only in pre-selected angular increments greater than at least one degree.

19. The system of claim 12 wherein said viewpoint can be changed in increments that are adjustable by a user.

20. The system of claim 12 wherein said display is part of an electronic flight bag.

21. The system of claim 12 wherein said user interface includes a graphic image having a circle positioned around an aircraft icon pointing in a particular direction, and wherein selecting a portion of the circle changes the viewpoint of the aircraft image displayed to the user to have an angular relationship that matches the portion of the circle relative to the aircraft icon.

22. The system of claim 12 wherein said location coincides with the current location of the aircraft.

23. The system of claim 12 wherein said location does not coincide with the current location of the aircraft.
